(19) United States
(12) Patent Application Publication
(10) Pub. No.: US 2017/0168694 A1
(43) Pub. Date: Jun. 15, 2017

(54) METHOD AND ELECTRONIC DEVICE FOR ADJUSTING SEQUENCE OF SHORTCUT SWITCHES IN CONTROL CENTER

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Junwei LIU, Beijing (CN)

(21) Appl. No.: 15/242,390

(22) Filed: Aug. 19, 2016

Related U.S. Application Data
(63) Continuation of application No. PCT/CN2016/088624, filed on Jul. 5, 2016.

(30) Foreign Application Priority Data
Dec. 15, 2015 (CN) 201510938078.2

(51) Int. Cl. G06F 3/0484; G06F 3/0482; G06F 3/0486

(52) U.S. Cl. CPC G06F 3/04847; G06F 3/0486; G06F 3/0482

(57) ABSTRACT

Embodiments of this application disclose a method and an electronic device for adjusting a sequence of shortcut switches in a control center. The method includes: determining a corresponding shortcut switch menu item based ora an initiation region of an input drag-and-drop operation in a control center interface; and moving the shortcut switch menu item to a termination region of the drag-and-drop operation.

### CROSS REFERENCE TO RELATED APPLICATIONS

This application is a continuation of International Application No. PCT/CN2016/088624, filed on Jul. 5, 2016, which is based upon and claims priority to Chinese Patent Application No. 201510938078.2, filed on Dec. 15, 2015, the entire contents of which are incorporated herein by reference.

### TECHNICAL FIELD

This application relates to the field of application software data processing technologies, for example, to a method and an electronic device for adjusting a sequence of shortcut switches in a control center.

### BACKGROUND

With the continuous development of communication technology, diversified functions are integrated into an intelligent terminal. For user's convenience, a control center is added into more and more intelligent terminals to achieve operations of some commonly used functions.

Currently, shortcut functions, such as Bluetooth, screen rotation, brightness adjustment and volume adjustment are mainly integrated in the control center. The user can rapidly complete shortcut switch operations of most functions in the control center interface. In the process of implementing this application, the inventor finds at least the following problems in the prior art: most shortcut functions in the control center are displayed in a predetermined sequence of the intelligent terminal, and the user cannot make adjustment. The user only can operate on the function after finding the predetermined position according to the sequence of the shortcut functions. As such, not only the user's operation on the shortcut function become cumbersome, but also the user's time is consumed, and the user experience is affected.

### SUMMARY

Embodiments of this application provide a method and an electronic device for adjusting a sequence of shortcut switches in a control center, so that the user can adjust the sequence of shortcut switches in the control center.

In a first aspect, embodiments of this application provide a method for adjusting a sequence of shortcut switches in a control center, which includes:

determining a corresponding shortcut switch menu item based on an initiation region of a drag-and-drop operation, in a control center interface; and

moving the shortcut switch menu item to a termination region of the drag-and-drop operation.

In a second aspect, embodiments of this application also provide an electronic device for adjusting a sequence of shortcut switches in a control center, which includes:

at least one processor; and

a memory commtmicably connected with the at least one processor for storing instructions executable by the at least one processor, wherein execution of the instructions by the at least one processor causes the at least one processor to:

determine a corresponding shortcut switch menu item based on an initiation region of a drag-and-drop operation, in a control center interface; and

move the shortcut switch menu item to a termination region of the drag-and-drop operation.

In a third aspect, embodiments of this application also provide a non-transitory computer-readable storage medium storing computer executable instructions that, when executed by an electronic device, cause the electronic device to:

determine a corresponding shortcut switch menu item based on an initiation region of a drag-and-drop operation, in a control center interface; and

move the shortcut switch menu item to a termination region of the drag-and-drop operation.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a control center interface to which the embodiment of this application is applicable;

HG. 2 is a schematic flowchart of a method for adjusting a sequence of shortcut switches in a control center according to some embodiments of this application;

FIG. 3 is a schematic flowchart of a method for adjusting a sequence of shortcut switches in a control center according to some embodiments of this application;

FIG. 4 is a schematic flowchart of a method for adjusting a sequence of shortcut switches in a control center according to some embodiments of this application;

FIG. 5 is a schematic diagram showing a display effect of a floating widget attribute in a method for adjusting a sequence of shortcut switches in a control center according to some embodiments of this application;

FIG. 6 is a schematic flowchart of a method for adjusting a sequence of shortcut switches in a control center according to some embodiments of this application;

HG. 7 is a schematic diagram showing a structure of a device for adjusting a sequence of shortcut switches in a control center according to some embodiments of this application; and

FIG. 8 is a structural schematic diagram showing hardware of an electronic device according to some embodiments of this application.

### DETAILED DESCRIPTION

Hereinafter, this application will be explained in detail with reference to the accompanying drawings and embodiments. The embodiments described herein are merely for explaining this application but are not intended to limit this application. Additionally, for illustrative purposes, those portions relevant to this application, not all the contents are shown in the accompanying drawings.

### A First Embodiment

FIG. 2 is a schematic flowchart of a method for adjusting a sequence of shortcut switches in a control center according to some embodiments of this application. This embodiment is applicable to adjust a display sequence of shortcut switch menu items in a control center interface of an intelligent terminal. The method can be performed by a device for adjusting the sequence of the shortcut switches in the control center, and the device can be implemented by software and/or hardware, and integrated in the intelligent terminal.

The method includes:

In S110, a corresponding shortcut switch menu item is determined based on an initiation region of a drag-and-drop operation inputted by a user in the control center interface.

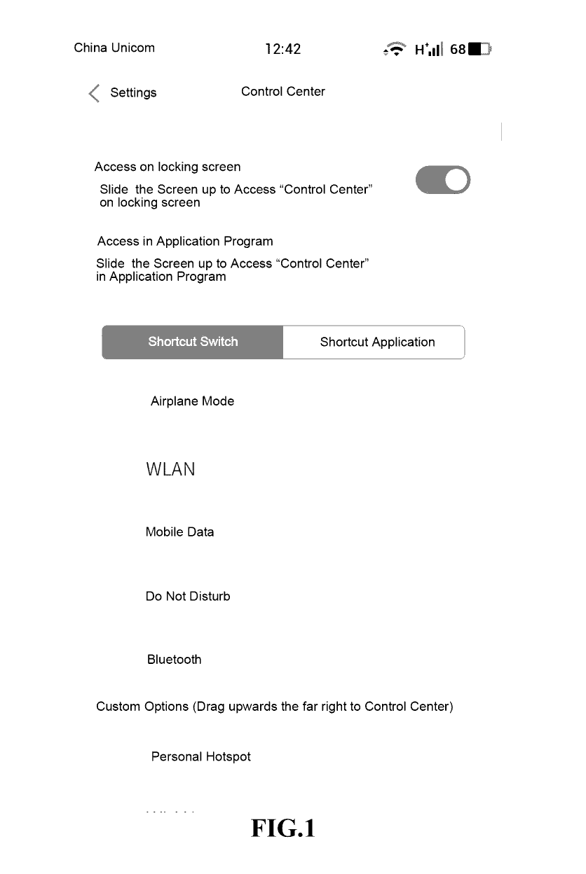

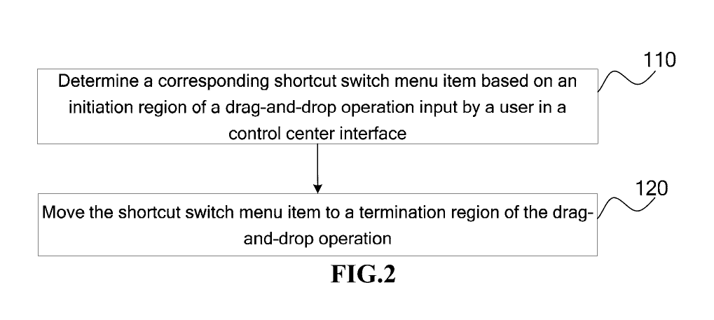

The intelligent terminal is provided with the control center interface, the user can enter the control center interface by clicking a shortcut on a desktop of the intelligent terminal, so as to perform setting operations on the commonly used functional switches in the control center. FIG. 1 is a schematic diagram of a control center interface to which the embodiment of this application is applicable. Referring to FIG. 1, a header item region, a control center interface setting region and a shortcut switch and shortcut application setting region are arranged sequentially from top to bottom of the control center interface. The header item region is used to remind the user of a theme of the current interface. The control center interface setting region is used to provide the user with a menu item for setting the control center interface, and the user can select a condition for accessing the control center via a switch option of the menu item. For example, the user can select whether to access on a locking screen and whether to access in an application program, by adjusting a switch of corresponding menu item in the control center interface setting region. The shortcut switch and shortcut application setting region is a rectangular region, which includes multiple shortcut switch menu items for performing setting operations on the commonly used functional switches, for example, such as airplane mode, mobile data, Bluetooth and wireless fidelity (WIFI). The shortcut switch menu items have approximately the same widths with the shortcut switch and shortcut application setting region, and are arranged sequentially from top to bottom according to the predetermined sequence in the shortcut switch and shortcut application setting region. A custom option region is also provided below the shortcut switch and shortcut application setting region, to facilitate the user to select a commonly used function to enter the control center according to usage habits.

Since different user may have different usage habits, the shortcut switch menu items arranged sequentially from top to bottom according to the predetermined sequence doesn't necessarily accord with customary usage habits of users. For instance, the user needs to set a WIFI shortcut switch frequently. However, the WIFI shortcut switch menu items are located at the bottom of the shortcut switch and shortcut application setting region according to a predetermined sequence, the user needs to search the shortcut switch menu item in the shortcut switch and shortcut application setting region each time, and then set the WIFI shortcut switch, which is inconvenient for the user to set the shortcut switches. In this embodiment, the user can adjust the sequence of the shortcut switch menu items by drag-and-drop operations.

The drag-and-drop operation refers to an operation that the user clicks a position on the surface of the touch screen of the intelligent terminal, and moves the finger from the surface of the touch screen after moving to other positions other than this position on the screen. The shortcut switch menu item which the user intends to move can be determined based on the user's drag-and-drop operation on the control center interface. Upon determining that the current screen displays the control center interface, the intelligent terminal captures the drag-and-drop operation and determines the position on the touch screen clicked by the user. Since the shortcut switch menu items are the same sized windows and thus have the same sized region ranges corresponding to them in the control center interface, the region range can be determined based on the position on the touch screen clicked by the user, and corresponding shortcut switch menu items can be determined based on the region range.

In S120, the shortcut switch menu item is moved to a termination region of the drag-and-drop operation.

The intelligent terminal can determine a position where the shortcut switch menu item is displayed in the shortcut switch and shortcut application setting region as the user desires, based on the user's drag-and-drop operation by presetting the shortcut switch menu item as an active window. The intelligent terminal determines a termination of the drag-and-drop operation based on changes in capacitance of the touch screen, and records a position where the user's finger leaves from the touch screen. Actually, this position is the termination position of the drag-and-drop operation. Since multiple regions in the control center interface have been allocated to the shortcut switch menu items in advance, the region corresponding to the termination position of the drag-and-drop operation is determined based on a comparison result of the termination position of the drag-and-drop operation and position coordinates of the multiple regions. The shortcut switch menu item determined in S110 is moved to the termination region of the drag-and-drop operation.

In this embodiment, the shortcut switch menu item selected by the user can be moved to an appropriate region by the user's drag-and-drop operation in the control center interface so that the user can adjust the display sequence of the shortcut switch menu items according to usage habits, further simplifying the operation on the shortcut switch, reducing user's operation time, and improving the user experience.

In an optional embodiment of this embodiment, after moving the shortcut switch menu item to the termination region of the drag-and-drop operation, the method also can further include a step of changing the current switch setting of the shortcut switch menu item. The user will set the switch corresponding to the shortcut switch menu item after adjusting the sequence of the shortcut switch menu items. In this embodiment, the intelligent terminal will change the current switch setting of the shortcut switch menu item after determining that the shortcut switch menu item is moved to the termination region of the drag-and-drop operation. Illustratively, if the user moves a Bluetooth shortcut switch menu item by a drag-and-drop operation, the current switch setting of the Bluetooth shortcut switch menu item is changed after completing the movement of the Bluetooth shortcut switch menu item, that is, if the Bluetooth shortcut switch menu item is ON before moving, the Bluetooth shortcut switch menu item is set to OFF; or, if the Bluetooth shortcut switch menu item is OFF before moving, the Bluetooth shortcut switch menu item is set to ON. The current switch setting of the shortcut switch menu item is changed, thereby reducing the user's operations, and improving the user experience.

### A Second Embodiment

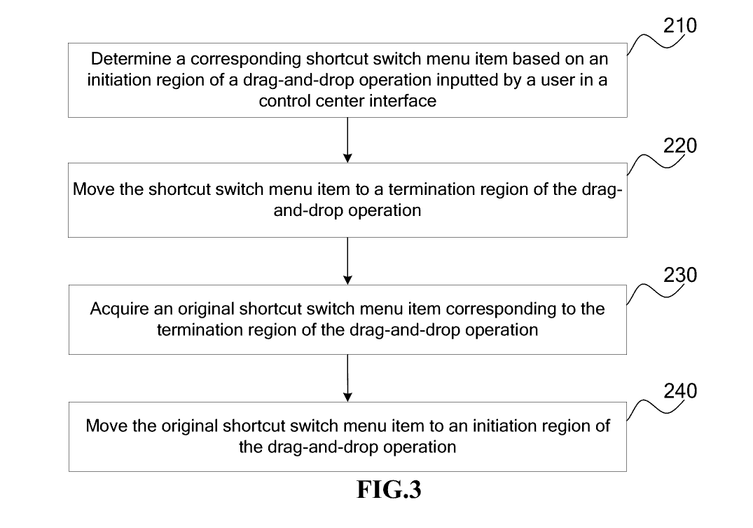

FIG. 3 is a schematic flowchart of a method for adjusting a sequence of shortcut switches in a control center according to some embodiments of this application. On the basis of the above embodiments, after moving the shortcut switch menu item to the termination region of the drag-and-drop operation, this embodiment further includes steps of: acquiring an original shortcut switch menu item corresponding to the termination region of the drag-and-drop operation; and moving the original shortcut switch menu item to an initiation region of the drag-and-drop operation.

Accordingly, the method in this embodiment includes:

In S210, a corresponding shortcut switch menu item is determined based on an initiation region of a drag-and-drop operation inputted by a user in a control center interface.

In S220, the shortcut switch menu item is moved to a termination region of the drag-and-drop operation.

In S230, an original shortcut switch menu item corresponding to the termination region of the drag-and-drop operation is acquired.

The intelligent terminal determines a termination of the drag-and-drop operation based on changes in capacitance of the touch screen, and records a position where the user's finger leaves from the touch screen. Actually, this position is the termination position of the drag-and-drop operation. Besides, the original shortcut switch menu item corresponding to this region prior to the drag-and-drop operation is acquired, based on the pre-divided regional position in the control center interface.

In S240, the original shortcut switch menu item is moved to the initiation region of the drag-and-drop operation.

Since the shortcut switch menu item is preset as an active window, the original shortcut switch menu item determined in S230 is moved to the initiation region of the drag-and-drop operation.

After moving the shortcut switch menu item to the termination region of the drag-and-drop operation this embodiment further includes steps of: acquiring the original shortcut switch menu item corresponding to the termination region of the drag-and-drop operation; and moving the original shortcut switch menu item to the initiation region of the drag-and-drop operation. An interchanging of two shortcut switch menu items can be achieved by one drag-and-drop operation, thereby simplifying the user's operation, and improving the user's application experience.

### A Third Embodiment

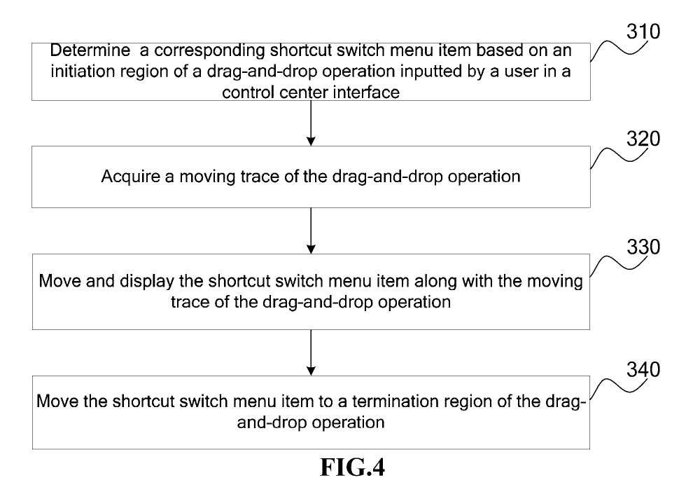

FIG. 4 is a schematic flowchart of a method for adjusting a sequence of shortcut switches in a control center according to some embodiments of this application. On the basis of the above embodiments, the step of moving the shortcut switch menu item to the termination region of the drag-and-drop operation in this embodiment includes: acquiring a moving trace of the drag-and-drop operation; and moving and displaying the shortcut switch menu item along with the moving trace of the drag-and-drop operation.

Accordingly, the method in this embodiment includes:

In S310, a corresponding shortcut switch menu item is determined based on an initiation region of the drag-and-drop operation inputted by a user in a control center interface.

In S320, a moving trace of the drag-and-drop operation is acquired.

When the user performs a drag-and-drop operation on the touch screen of the intelligent terminal, the finger slides on the touch screen. The intelligent terminal can determine a position of the finger on the touch screen based on changes in a capacitance value of the touch screen, and determine a moving trace of the user's finger, namely, the moving trace of the user's drag-and-drop operation based on the position of the finger on the touch screen.

In S330, the shortcut switch menu item is moved and displayed along with the moving trace of the drag-and-drop operation.

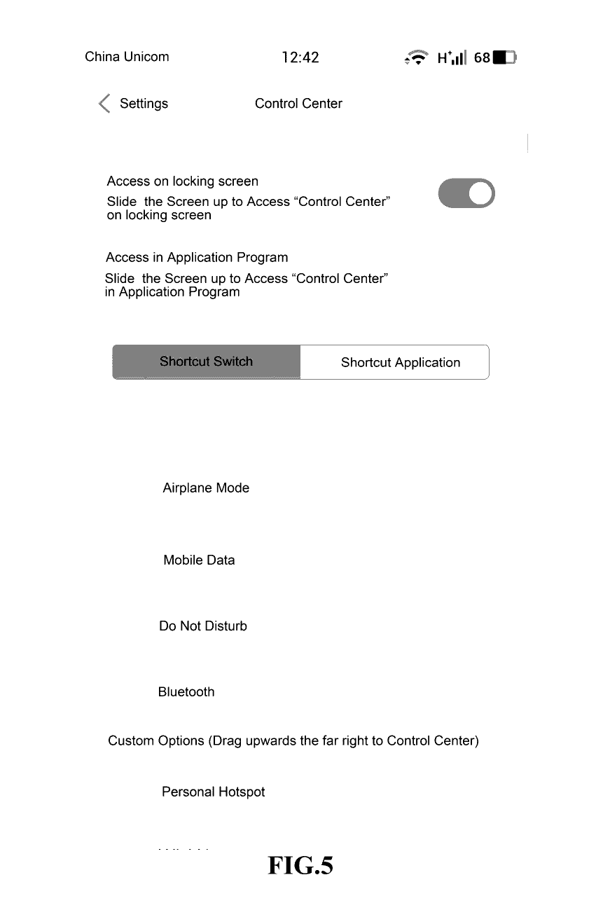

In this embodiment, the shortcut switch menu item is set as a floating widget attribute. FIG. 5 is a schematic diagram showing a display effect of the floating widget attribute. Illustratively, in an Android system, management classes, such as a Window Manager can be used to set a widget attribute of the shortcut switch menu item as the floating widget, so that the shortcut switch menu item can be displayed with a floating widget effect as an airplane mode shortcut switch menu item shown in FIG. 5. In this embodiment, the shortcut switch menu item can be displayed with the floating widget attribute and move along with the user's finger during the user's drag-and-drop operation. The shortcut switch menu item corresponding to the initiation region of the drag-and-drop operation inputted by the user is the airplane mode shortcut switch menu item, which is preset as the floating widget attribute. The intelligent terminal scans regularly a position of the user's finger on the touch screen during the drag-and-drop operation based on a predetermined time interval, and moves the airplane mode shortcut switch menu item based on the regularly scanned position. Since the duration time for the drag-and-drop operation is very short, corresponding time interval is determined by an empirical value, and is generally set to be a short time length. In this way, the user can visually perceive that the shortcut switch menu item moves continuously, thereby generating a better visual effect.

The step of moving the shortcut switch menu item to the termination region of the drag-and-drop operation in this embodiment includes: acquiring the moving trace of the drag-and-drop operation; and moving and displaying the shortcut switch menu item along with the moving trace of the drag-and-drop operation. The user can observe a position where the shortcut switch menu item currently moves, and determine whether to terminate the drag-and-drop operation based on the current position, thereby avoiding the user from moving the shortcut switch menu item to a wrong position, and improving user experience. Moreover, since the shortcut switch menu item is moved and displayed along with the moving trace of the drag-and-drop operation, a better visual experience can be provided for the user.

### A Fourth Embodiment

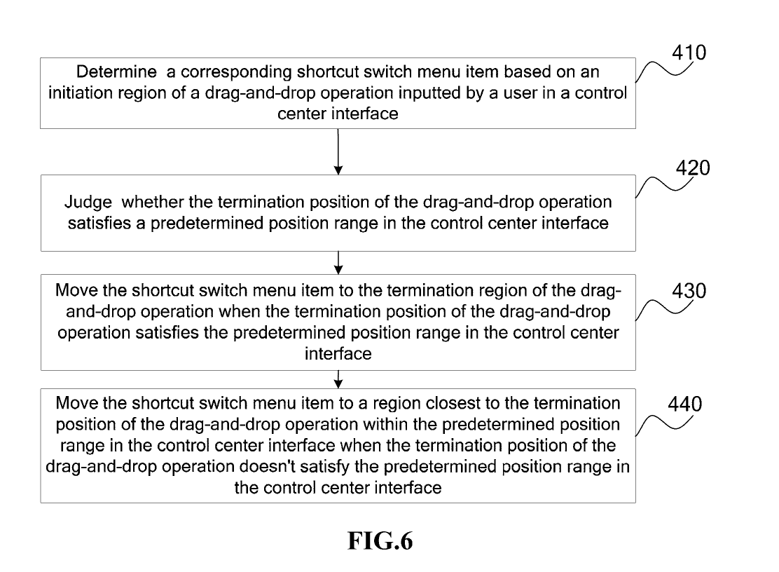

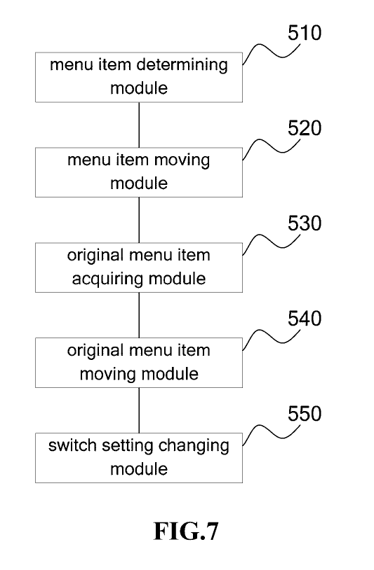

FIG. 6 is a schematic flowchart of a method for adjusting a sequence of shortcut switches in a control center according to some embodiments of this application. On the basis of the above embodiments, the step of moving the shortcut switch menu item to the termination region of the drag-and-drop operation in this embodiment includes: judging whether the termination position of the drag-and-drop operation satisfies a predetermined position range in the control center interface; moving the shortcut switch menu item to the termination region of the drag-and-drop operation if the termination region of the drag-and-drop operation satisfies the predetermined position range in the control center interface; and moving the shortcut switch menu item to a region closest to the termination position of the drag-and-drop operation within the predetermined position range in the control center interface if the termination region of the drag-and-drop operation doesn't satisfy the predetermined position range in the control center interface.

Accordingly, the method in this embodiment includes:

In S410, a corresponding shortcut switch menu item is determined based on an initiation region of the drag-and-drop operation inputted by a user in the control center interface.

In S420, whether the termination position of the drag-and-drop operation satisfies the predetermined position range in the control center interface is judged.

Since there is a deviation between the termination position of the drag-and-drop operation and the user's desired position when the user performs the drag-and-drop operation, the termination position of the drag-and-drop operation may exceed the predetermined position range in the control center interface. Whether the termination position of the drag-and-drop operation satisfies the predetermined position range in the control center interface can be determined based on changes in capacitance of the touch screen of the intelligent terminal, illustratively, the intelligent terminal determines a termination of the drag-and-drop operation based on changes in capacitance of the touch screen, and records a position where the user's finger leaves from the touch screen. The recorded position is compared with boundary coordinates of the predetermined position range in the control center interface. In this embodiment, the predetermined position range in the control center interface is a range of the shortcut switch and shortcut application setting region. If the position coordinates when the user's finger leaves from the touch screen are located within a range of boundary coordinates of the shortcut switch and shortcut application setting region, the termination position of the drag-and-drop operation satisfies the predetermined position range in the control center interface; if the position coordinates when the user's finger leaves from the touch screen are not located within the range of boundary coordinates of the shortcut switch and shortcut application setting region, the termination position of the drag-and-drop operation doesn't satisfy the predetermined position range in the control center interface.

In S430, the shortcut switch menu item is moved to the termination region of the drag-and-drop operation when the termination position of the drag-and-drop operation satisfies the predetermined position range in the control center interface.

If the termination position of the drag-and-drop operation satisfies the predetermined position range in the control center interface, it indicates that there is no deviation in the termination position of the user's drag-and-drop operation, and the shortcut switch menu item is moved to the termination region of the drag-and-drop operation.

In S440, the shortcut switch menu item is moved to the region closest to the termination position of the drag-and-drop operation within the predetermined position range in the control center interface when the ending position of the drag-and-drop operation doesn't satisfy the predetermined position range in the control center interface.

If the termination position of the drag-and-drop operation doesn't satisfy the predetermined position range in the control center interface, it indicates that there is a deviation the termination position of the user's drag-and-drop operation, it is necessary to select an appropriate region based on the acquired termination position of the drag-and-drop operation. In this embodiment, based on the termination position of the drag-and-drop operation, distances between the termination position and the regions corresponding to all the shortcut switch menu items in the predetermined position of the control center interface are calculated, respectively, the region closest to the termination region of the drag-and-drop operation is then determined and is taken as the region corresponding to the termination position of the drag-and-drop operation, the shortcut switch menu item is moved to the region closest to the termination region of the drag-and-drop operation within the predetermined position range in the control center interface.

The step of moving the shortcut switch menu item to the termination region of the drag-and-drop operation in this embodiment includes judging whether the termination region of the drag-and-drop operation satisfies the position range in the control center interface; moving the shortcut switch menu item to the termination region of the drag-and-drop operation if the termination region of the drag-and-drop operation satisfies the predetermined position range in the control center interface; and moving the shortcut switch menu item to the region closest to the termination region of the drag-and-drop operation within the position range in the control center interface if the termination region of the drag-arid-drop operation doesn't satisfy the predetermined position range in the control center interface. When there is a deviation in the user's drag-and-drop operation, an appropriate region is selected based on the acquired termination position of the drag-and-drop operation, so that the shortcut switch menu item can move to the user's desired position.

### A Fifth Embodiment

FIG. 7 is a schematic diagram showing a structure of a device for adjusting a sequence of shortcut switches in a control center according to sonic embodiments of this application. As shown in FIG. 7, the device includes: a menu item determining module 510 and a menu item moving module 520.

The menu item determining module 510 is configured to determine a corresponding shortcut switch menu item based on an initiation region of a drag-and-drop operation inputted by a user in a control center interface; and

the menu item moving module 520 is configured to move the shortcut switch menu item to a termination region of the drag-and-drop operation.

In the device for adjusting the sequence of shortcut switches in the control center in this embodiment, the shortcut switch menu item selected by the user can be moved to an appropriate region by the user's drag-and-drop operation in the control center interface, so that the user can adjust a display sequence of the shortcut switch menu items according to usage habits, further simplifying the operations on the shortcut switch, reducing user's operation time, and improving the user experience.

On the basis of the above embodiments, the device also includes: an original menu item acquiring module 530 and an original menu item moving module 540.

The original menu item acquiring module 530 is configured to acquire an original shortcut switch menu item corresponding to the termination region of the drag-and-drop operation after moving the shortcut switch menu item to the termination region of the drag-and-drop operation; and the original menu item moving module 540 is configured to move the original shortcut switch menu item to the initiation region of the drag-and-drop operation.

On the basis of the above embodiments, the Menu item moving module 520 includes: a moving trace acquiring unit 521 and a menu item moving unit 522.

The moving trace acquiring unit 521 is configured to acquire a moving trace of the drag-and-drop operation:

the menu item moving unit 522 is configured to move and display the shortcut switch menu item along with the moving trace of the drag-and-drop operation.

On the basis of the above embodiments, the menu item moving module 520 is configured to:

judge whether the termination region of the drag-and-drop operation satisfies a predetermined position range in the control center interface;

move the shortcut switch menu item to the termination region of the drag-and-drop operation if the termination region of the drag-and-drop operation satisfies the predetermined position range in the control center interface; and

move the shortcut switch menu item to a region closest to the termination region of the drag-and-drop operation within the predetermined position range in the control center interface if the termination region of the drag-and-drop operation doesn't satisfy the predetermined position range in the control center interface.

On the basis of the above embodiments, the device also includes:

a switch setting changing module 550 configured to change the current switch setting of the shortcut switch menu item after moving the shortcut switch menu item to the termination region of the drag-and-drop operation.

The device for adjusting the sequence of shortcut switches in the control center in the embodiments of this application can be used to perform the method for adjusting the sequence of shortcut switches in the control center in any embodiment of this application, has corresponding function modules and achieves the same beneficial effects. It will be apparent for those skilled in the art that various modules or operations in the above application can be implemented by the terminal device described above. Optionally, embodiments of this application may be implemented by a computer-executable program, which thus may be stored on a storage device and be executed by a processor. The program may be stored in a computer-readable storage medium, such as a read only memory, a floppy disk, or an optical disk; or the program may be made into various integrated circuit modules, or a plurality of modules or operations in the program are made into a single integrated circuit module. This application is not limited to any particular combination of hardware and software.

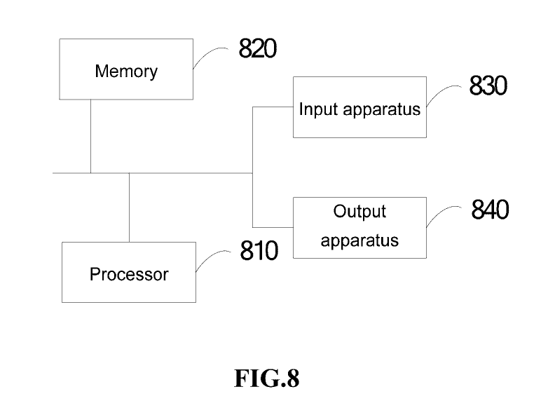

FIG. 8 is a structural schematic diagram of hardware of an electronic device according to some embodiments of this application_{—} As shown in FIG. 8, the electronic device includes:

one or more processors 810 and a memory 820, one processor 810 is taken as an example in FIG. 8.

The electronic device also may include: an input apparatus 830 and an output apparatus 840.

The processor 810, the memory 820, the input apparatus 830 and the output apparatus 840 in the electronic device may be connected by a bus or other means, the bus connection is taken as an example in FIG. 8.

The memory 820, as a non-transitory computer-readable storage medium, may be used to store a non-transitory software program, a non-transitory computer-executable program and module, such as the program instruction/module corresponding to the method for adjusting a sequence of shortcut switches according to embodiments of this application. The processor 810 may perform various functional applications and data processing of the server by running the non-transitory software program, instruction and module stored in the memory 820, that is, the method for controlling the shortcut switch according to the above method embodiment is achieved.

The memory 820 may include a storage program area and a storage data area. The storage program area can store an operating system and an application program required by at least one function; the storage data area can store data created based on the use of the device for controlling the shortcut switch. Besides, the memory 820 may include a high-speed random access memory, and also a non-transitory memory, such as at least one magnetic disk storage device, flash memory device or other non-transitory solid state storage device. In some embodiments, the memory 820 optionally includes memories remotely configured relative to the processor 810, these remote memories can be connected to the device for controlling the shortcut switch through the network. Examples of the network include, but are not hunted to, the Internet, an intranet, a local area network, a mobile communication network and combinations thereof.

The input apparatus 830 may receive the input figure or character information and generate key signal input associated with the user setting and functional control of the device for controlling the shortcut switch. The output apparatus 840 may include a display device, such as a display screen.

One or more modules are stored in the memory 820, when one or more modules are executed by the one or more processors 810, the method for controlling a shortcut switch in any of the above method embodiments is performed,

The electronic device in embodiments of this application exists in various forms, including but not limited to:

(1) mobile telecommunication device. A device of this kind has a feature of mobile communicating function, and has a main object of providing voice and, data communication. Devices of this kind include smart phone (such as IPHONE), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as IPOD), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided:

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for adjusting a sequence of shortcut switches in a control center, comprising steps of:
determining a corresponding shortcut switch menu item based on an initiation region of a drag-and-drop operation in a control center interface; and
moving the shortcut switch menu item to a termination region of the drag-and-drop operation.

2. The method according to claim 1, wherein after moving the shortcut switch menu item to the termination region of the drag-and-drop operation, the method further comprises:
acquiring an original shortcut switch menu item corresponding to the termination region of the drag-and-drop operation; and
moving the original shortcut switch menu item to the initiation region of the drag-and-drop operation.

3. The method according to claim 1, wherein the step of moving the shortcut switch menu item to the termination region of the drag-and-drop operation comprises:
acquiring a moving trace of the drag-and-drop operation; and
moving and displaying the shortcut switch menu item along with the moving trace of the drag-and-drop operation.

4. The method according to claim 1, wherein the step moving the shortcut switch menu item to the termination region of the drag-and-drop operation comprises:
judging whether the termination region of the drag-and-drop operation satisfies a predetermined position range in the control center interface;
moving the shortcut switch menu item to the termination region of the drag-and-drop operation if the termination region of the drag-and-drop operation satisfies the predetermined position range in the control center interface; and.
moving the shortcut switch menu item to a region closest to the termination region of the drag-and-drop operation within the predetermined position range in the control center interface if the termination region of the drag-and-drop operation doesn't satisfy the predetermined position range in the control center interface.

5. The method according to claim 1, wherein after moving the shortcut switch menu item to the termination region of the drag-and-drop operation, the method further comprises:
changing the current switch setting of the shortcut switch menu item.

6. An electronic device for adjusting a sequence of shortcut switches in a control center, comprising:
at least one processor; and
a memory communicably connected with the at least one processor for storing instructions executable b the at least one processor, wherein execution of the instructions by the at least one processor causes the at least one processor to:
determine a corresponding shortcut switch menu item based on an initiation region of a drag-and-drop operation in a control center interface; and
move the shortcut switch menu item to a termination region of the drag-and-drop operation.

7. The electronic device according to claim 6, wherein the execution of the instructions by the at least one processor further causes the at least one processor to:
acquire an original shortcut switch menu item corresponding to the termination region of the drag-and-drop operation after moving the shortcut switch menu item to the termination region of the drag-and-drop operation; and
move the original shortcut switch menu item to an initiation region of the drag-and-drop operation.

8. The electronic device according to claim 6, wherein the execution of the instructions by the at least one processor Ruttier causes the at least one processor to:
acquire a moving trace of the drag-and-drop operation; and
move and display the shortcut switch menu item along with the moving trace of the drag-and-drop operation.

9. The electronic device according to claim 6, wherein the execution of the instructions by the at least one processor further causes the at least one processor to:
judge Whether the termination region of the drag-and-drop operation satisfies a predetermined position range in the control center interface;
move the shortcut switch menu item to the termination region of the drag-and-drop operation if the termination region of the drag-and-drop operation satisfies the predetermined position range in the control center interface; and
move the shortcut switch menu item to a region closest to the termination region of the drag-and-drop operation within the predetermined position range in the control center interface if the termination region of the drag-and-drop operation doesn't satisfy the predetermined position range in the control center interface.

10. The electronic device according to claim 6, wherein the execution of the instructions by the at least one processor further causes the at least one processor to:
change the current switch setting of the shortcut switch menu item after moving the shortcut switch menu item to the termination region of the drag-and-drop operation.

11. A non-transitory computer-readable storage medium storing executable instructions that, when executed by an electronic device, cause the electronic device to:
determine a corresponding shortcut switch menu item based on au initiation region of a drag-and-drop operation in a control center interface; and
move the shortcut switch menu item to a termination region of the drag-and-drop operation.

12. The non-transitory computer-readable storage medium according to claim 11, wherein after moving the shortcut switch menu item to the termination region of the drag-and-drop operation, the executable instructions cause the electronic device to:
acquire an original shortcut switch menu item corresponding to the termination region of the drag-and-drop operation; and
move the original shortcut switch menu item to the initiation region of drag-and-drop operation.

13. The non-transitory computer-readable storage medium according to claim 11, wherein when moving the shortcut switch menu item to the termination region of the drag-and-drop operation, the executable instructions cause the electronic device to:
acquire a moving trace of the drag =awl-drop operation awl
move and display the shortcut switch menu item along with the moving trace the drag-and-drop operation.

14. The non-transitory computer-readable storage medium according to claim 11, wherein when moving the shortcut switch menu item to the tern nation region of the drag-and-drop operation, the executable instructions cause the electronic device to:
judge whether the termination region of the drag-and-drop operation satisfies a predetermined position range in the control center interface;
move the shortcut switch menu item to the termination region of the drag-and-drop operation if the termination region of the drag-and-drop operation satisfies the predetermined position range in the control center interface; and
move the shortcut switch menu item to a region closest to the termination region of the drag-and-drop operation within the predetermined position range in the control center interface if the termination region of the drag-and-drop operation doesn't satisfy the predetermined position range in the control center interface.

15. The non-transitory computer-readable storage medium according to claim 11, wherein after moving the shortcut switch menu item to the termination region of the drag-and-drop operation, the executable instructions cause the electronic device to:
change the current switch setting of the shortcut switch menu item.
